(19) United States
(12) Patent Application Publication
(10) Pub. No.: US 2022/0072345 A1
(43) Pub. Date: Mar. 10, 2022

(54) FACE MASK

(71) Applicant: One Science LLC, Santa Monica, CA (US)

(72) Inventors: Justin Viles, Pacific Palisades, CA (US); George Rivera, Chatsworth, CA (US)

(21) Appl. No.: 17/468,844

(22) Filed: Sep. 8, 2021

Related U.S. Application Data
(60) Provisional application No. 63/076,080, filed on Sep. 9, 2020.

(51) Int. Cl. A62B 18/08; A41D 13/11; B01D 46/42; B01D 39/20; B01D 46/00; B01D 46/44; A62B 23/02

(52) U.S. Cl. CPC A62B 18/08; A41D 13/11; B01D 46/4272; B01D 46/4245; B01D 2273/30; B01D 46/002; B01D 46/44; A62B 23/02; B01D 39/2055

(57) ABSTRACT

Implementations of the disclosed subject matter provide face mask that may include a transparent portion configured to cover a nose and mouth when disposed on a wearer, where the transparent portion includes a left front opening and a right front opening. A first strap and a second strap may be affixed to the transparent portion. A first filter may be configured to be removably disposed in the left front opening of the transparent portion to filter air, and a second filter configured to be removably disposed in the right front opening of transparent portion to filter the air. A first module may be configured to be removably affixed to the first filter and a second module configured to be affixed to the second filter. The modules may include a controller, a fan, a speaker, a microphone, a display, a memory, a communications interface, and/or a plurality of light emitting devices.

### CROSS-REFERENCE TO RELATED APPLICATIONS

This application claims priority to U.S. Provisional Patent Application Ser. No. 63/076,080, filed Sep. 9, 2020, the disclosure of which is incorporated by reference in its entirety.

### BACKGROUND

Traditional surgical masks, as well as other fabric-based masks, cover a portion of a nose and mouth of a wearer. Such masks have elastic straps or tie straps that are secured around the head or the ears of the wearer.

### BRIEF SUMMARY

According to an implementation of the disclosed subject matter, a face mask is provided that may include a transparent portion configured to cover a nose and mouth of a wearer so that the mouth of the wearer is visible, where the transparent portion includes a left front opening and a right front opening. A first strap and a second strap may be affixed to the transparent portion and configured to secure the transparent portion to a head of the wearer. A first filter may be configured to be removably disposed in the left front opening of the transparent portion to filter air. A second filter may be configured to be removably disposed in the right front opening of transparent portion to filter the air. The face mask may include a first module configured to be removably affixed to the first filter and a second module configured to be affixed to the second filter, where at least one of the first module and the second module includes a controller and at least one of a fan, a speaker, a microphone, a display, a communications interface, a memory, and/or a plurality of light emitting devices.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1A shows a face mask according to a first implementation of the disclosed subject matter.

FIG. 1B shows an exploded view of the face mask of FIG. 1A according to an implementation of the disclosed subject matter.

FIG. 2A shows a first side the face mask of FIGS. 1A-1B without filters, and FIG. 2B shows a second side (towards the face of the wearer) of the face mask of FIGS. 1A-1B according to an implementation of the disclosed subject matter.

FIG. 3A shows a top view of the face mask of FIGS. 1A-1B, and FIG. 3B shows a bottom view of the face mask of FIGS. 1A-1B according to an implementation of the disclosed subject matter.

FIG. 4A shows a side view of the face mask of FIGS. 1A-1B, and FIG. 4B shows another side view of the face mask that includes a filter cover and a strap according to an implementation of the disclosed subject matter.

FIGS. 5A-5B show additional views of the second side of the face mask of FIG. 2B according to an implementation of the disclosed subject matter.

FIGS. 6A-6H show views of a second implementation of the face mask of FIGS. 1A-5B according to implementations of the disclosed subject matter.

FIGS. 7A-7D show views of modules that may be attached to the face mask of FIGS. 1A-5B and/or FIGS. 6A-6H according to implementations of the disclosed subject matter.

FIG. 8 shows an example system with a face mask that may be communicatively coupled to a mobile device and/or a communications network having one or more servers and/or databases according to an implementation of the disclosed subject matter.

### DETAILED DESCRIPTION

Implementations of the disclosed subject matter provide a face mask that may seal around the mouth and/or nose of a wearer, may include removable and/or replaceable filters to filter air, and may include an plurality of straps that are adjustable, along with a strap connecter to hold a portion of the plurality of straps together. The face mask may include a transparent portion that allows the mouth of the wearer to be visible to others. Different sizes of the mask may be available to accommodate different sizes of faces and/or facial features of the mask wearer. The face mask may include modules that are removably affixed to the filters. The modules may include a controller, which may control a fan, a speaker, a microphone, a display, a memory, a communications interface, and/or a plurality of light emitting devices of the modules.

The face mask may include a transparent and/or clear portion, which may be made of a material (e.g., silicone or the like) and/or be coated to prevent fogging while covering the mouth of a wearer. The material of the transparent portion of the face mask may be configured so that the face mask may be folded for portability purposes. The face mask may be reusable, and/or may be sterilized for reuse without damaging the face mask.

The filters of the face mask may be replaceable, where different filters may provide increasing filtering properties (e.g., Respirator Rating Letter Class of N95, which may filter non oil-based particulates). Other filters may include R95 (e.g., resistant to oil for 8 hours) and P95 (e.g., oil proof filters), or the like.

The face mask may be configured to accommodate different replaceable filters, having different thicknesses. Thicker filters may use different covers and/or grills to removably attach them to the mask to accommodate a larger thickness.

The face mask provide filtration with the replaceable filters, and may also include removeable modules that may coupled to the filters. The removeable modules may include a fan, a microphone, a communications interface, a speaker, a display, and/or a plurality of light emitting devices. The speaker may output sound and/or voice based on a signal from the controller and/or communications interface. The communications interface may provide communication between one module and another module of the face mask, and/or provide communicate with other mobile devices (e.g., a smart phone, smart watch, tablet computer, or the like) and/or with other devices (e.g., a server, a database, or the like) via a communications network. The microphone may convert voice to a signal that may be transmitted via the communications interface. The display and/or the plurality of light emitting devices may display symbols, messages (e.g., in text), translated text, or the like.

A seal may be formed between the transparent portion and the filters and/or modules to minimize and/or prevent air leakage (e.g., under sustained pressure). The seal may be formed with filter housing with a module that includes one or more of a controller, a fan, a speaker, a microphone, a memory, a communications interface, a display, and a plurality of light emitting devices, and the like. The filters and/or modules may include a flange or the like to form the seal with the transparent portion of the face mask.

The removable modules may include one or more of a controller, a fan, a speaker, a microphone, a memory, a communications interface, a display, and a plurality of light emitting devices, and the like. For example, the module may be used for voice amplification, such as through a speaker. That is, when a wearer talks, a microphone of the module may convert the voice to a signal, that may be amplified and output by a speaker. The microphone of the module may be connected to a communications interface, which may form a wireless communications link between the face mask and a mobile device (e.g., smart phone, smart watch, wearable computing device, or the like). For example, voice may be converted by the microphone to a signal, which may be transmitted to the mobile device (e.g., a smart phone of the wearer of the mask), and from the mobile device to a communications network to one or more other devices. The microphone, controller, and communications interface may transmit a wearer's commands and/or speech to a server or mobile device which may perform a language translation, where the translated voice may be output as text on the display and/or by the light emitting devices. In some implementations, the display and/or the light emitting devices may output the text of the received voice, and the translated text of the voice. In some implementations, the display or the light emitting devices of a first module may output the text of the received voice, and the display or the light emitting devices of the second module may output the translated text.

The commands and/or voice may be output as symbols, a safety message, text, and/or scrolling text on the display and/or light emitting devices of the module. The scrolling text may move from one module of the face mask to another, such as from the display of the left module to the display of the right module. Symbols, text, lighting patterns, or the like may be scrolled across the displays of the modules of the face mask, and/or may be synchronized. For example, the plurality of light emitting devices may be controlled to be synchronized to music, and/or may control the synchronization of illumination of one or more of the light emitting devices over different modules and/or masks (via a wireless communications link) in clusters of persons wearing the face mask or in a linear arrangement of persons wearing the face mask.

The fan of the module may be controlled by the controller to have a plurality of different speeds. The fan may provide air circulation within the face mask, and provide increased comfort for the wearer. The fan may remove moisture from within the mask when the mask is being worn and the wearer is breathing.

The face mask disclosed herein improves upon traditional surgical masks and/or cloth masks, as the body of the face mask may maintain a seal between the mask and the face of the wearer, and may be transparent so that the mouth of the wearer may be visible. This allows others that may be hearing impaired to view the mouth of the wearer.

In implementations of the disclosed subject matter, at least one section of the body of the mask may be configured to form a seal around the nose and mouth of the wearer, and improves upon traditional masks that typically have gaps between the edge of the mask and the face of the wearer. Traditional masks do not typically include filters that may be replaceable, such as with the face mask of the disclosed subject matter. The filters of the face mask disclosed herein may be replaceable, and different filters may provide increased protection. Traditional surgical masks and cloth masks are available in a single size, which may make it difficult for a wearer to have a comfortable and protective mask fit, and the filtering capabilities of traditional masks cannot be changed. Implementations of the disclosed subject matter provide a mask which integrates modules that include fans to remove moisture from the face mask, and may include a microphone, speakers, a display, a communication interface, and/or light emitting devices to provide communication and/or safety features. The modules may be removeable, and may be coupled to the replaceable filters.

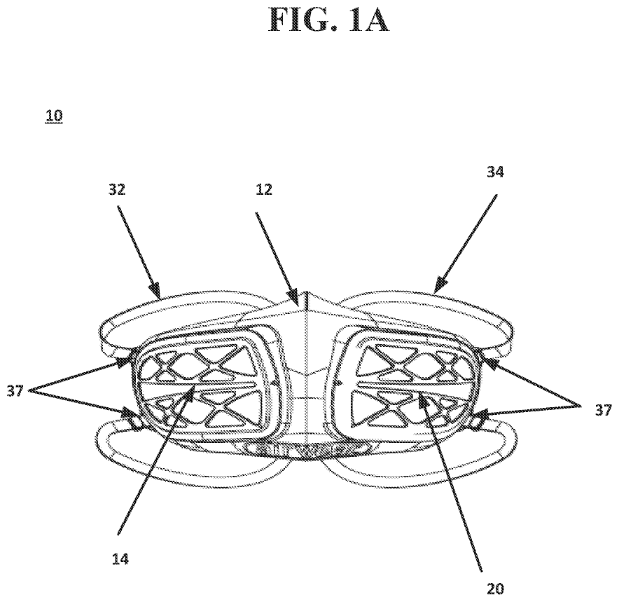

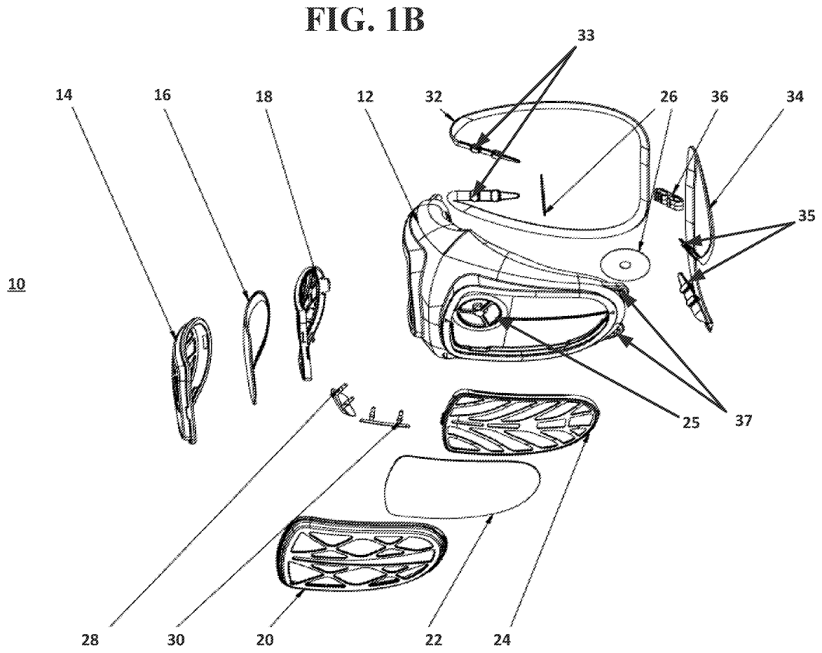

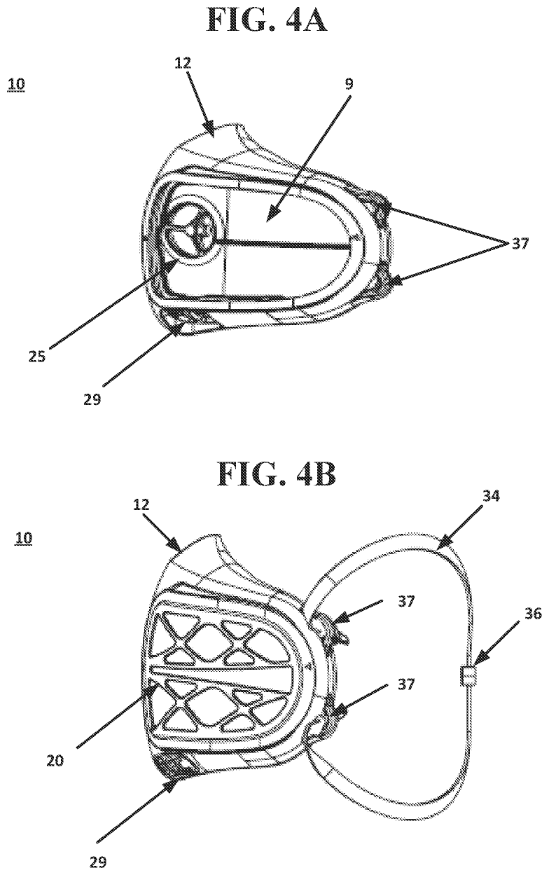

FIGS. 1A-5B show an implementation of a face mask 10 having a body 12. FIG. 1A shows the face mask 10 in fully assembled form, and FIG. 1B shows an exploded view of the face mask 10. As shown in FIGS. 1A-1B, the face mask 10 may include the body 12, which may be transparent and made from silicone, a polymer material, and/or any other suitable material which may maintain a seal with a face of the wearer of the mask as the face of the wearer moves. The transparent material of the body 12 may be configured to cover a nose and mouth when disposed on a wearer, and may prevent fogging. The body 12 may be foldable such that the face mask 12 may be portable and/or compactable. The face mask 10 may be reusable, and may be sterilized for reuse without damaging the face mask.

Filter 16 may be disposed between outside filter cover 14 and inside filter cover 18. The assembly of filter covers 14, 18 and filter 16 may be disposed on the body 12 of the face mask 10 in opening 8. Similarly, filter 22 may be disposed between outside filter cover 20 and inside filter cover 24. The assembly of the filter covers 20, 24 and filter 22 may be disposed on the body 12, and/or may be press fit to the body 12 in opening 9. Filters 16, 22 may be replaceable. The filters 16, 22 may provide similar filtration and/or protection as a N95, P95, and/or R95 mask or respirator. In some implementations, filters 16, 22 may be charcoal-based filters. The face mask 10 and filters 16, 22 may protect the wearer from airborne particles and/or from liquid contaminating the face. Outside filter covers 14, 22 and inside filter covers 18, 24 may protect the filters 16, 22 from damage, and/or may provide structural support to the filters 16, 22.

The filters 16, 22 may be replaceable, where different filters may provide increasing filtering properties. For example, the filters 16, 22 may be N95 filters, which may filter non oil-based particulates. The N95 filters may be replaced with R95 filters, which may be resistant to oil for 8 hours. The filters 16, 22 may be replaced with P95 filters, which may be oil proof filters. Covers 14, 18, 20, and 24 for filters 16, 22 may be differently sized to accommodate when filters 16, 22 are thicker to provide increased filtration (e.g., when the filters 16, 22 are R95 and/or P95 filters). That is, the face mask 10 may be configured to accommodate different replaceable filters, having different thicknesses. Thicker filters 16, 22 may use different covers and/or grills 14, 18, 20, and 24 to removably attach them to the body 12 of the face mask 10 to accommodate the increased thickness of the filters.

Inside filter covers 18, 24 may form a seal with an edge of the openings 8, 9 of the body 12 of the face mask 10. Outside filter cover 14 may form a seal with one another and with inside filter cover 18, and outside filter cover 20 may form a seal with inside filter cover 24. The assembly of filter covers 14, 18 and filter 16 may form a seal with one another and with the edge of the opening 8 of the body 12 of face mask 10, and the assembly of filter covers 20, 24 and filter 22 may form a seal with one another and with an edge of the opening 9 of the body 12 of the face mask 10.

The outside filter cover 14 and the inside filter cover 18 may have a plurality of openings. Similarly, the outside filter cover 20 and the inside filter cover 24 may have a plurality of openings. The covers 14, 18, 20, and 24 may provide structural support for the filters 16 and 22, and the plurality of openings in covers 14, 18, 20, and 24 may reduce the weight of the covers to help reduce the weight of the face mask 10.

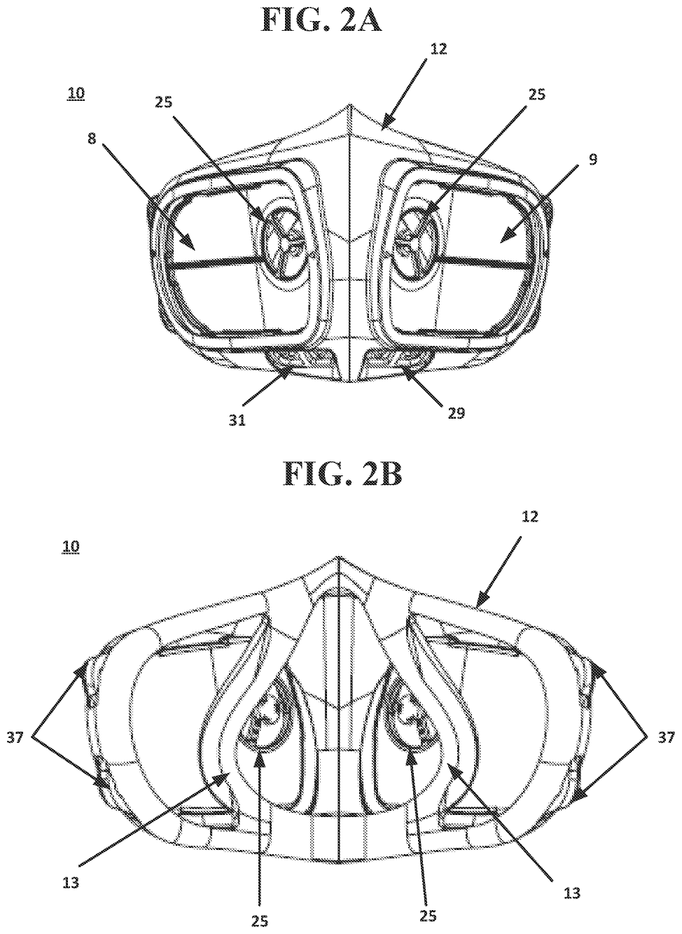

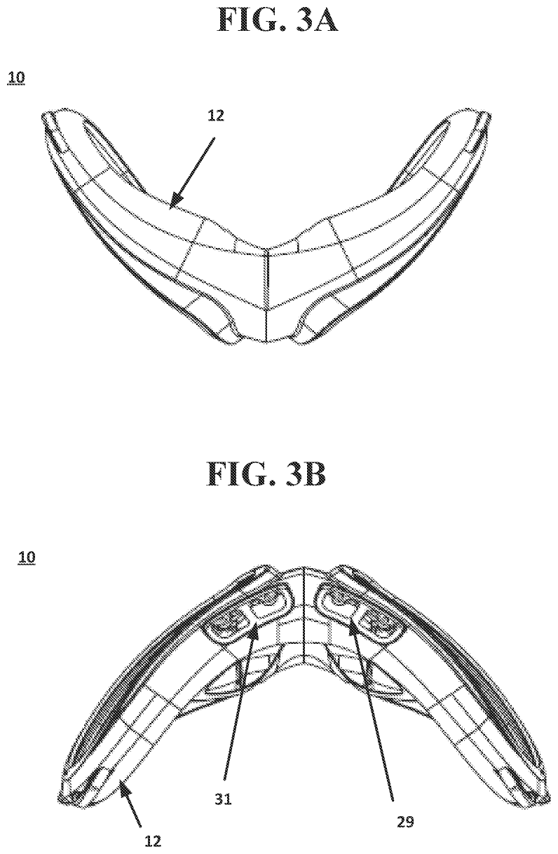

Valves 26 may be affixed to valve interface 25 (e.g., as shown in FIGS. 1B and 2A-2B) of the body 12 of the face mask 10. Valves 26 may be adjusted to regulate the flow of filtered air from filters 16, 22. Valves 28, 30 may be affixed to the body 12 of the face mask 10. For example, valve 28 may be affixed to valve interface 29 (e.g., as shown in FIGS. 2B and 3B), and valve 30 may be affixed to valve interface 31 (e.g., as shown in FIGS. 2B and 3B). Valves 28, 30 may be adjusted to regulate air flow into the body 12 of the face mask 10 to be filtered by filters 16, 22. As discussed below, the valves 28, 30 may be adjusted and/or interlocked with the valve interfaces 29, 31 to control passage of the air through the filters 16, 22.

Strap 32 may include tabs 33, and strap 34 map include tabs 35. The tabs 33, 35 may be used to adjust the length of the straps 32, 34 when the straps 32, 34 are positioned within eyelets 37 (e.g., shown in FIGS. 1B, 2B, 4A-4B, and 5B). The length of straps 32, 34 may be adjusted using tabs 33, 35 so that the face mask 10 may fit the face of the wearer and/or maintain a seal against the face of the wearer. Straps 32, 34 may be coupled to one another with strap connector 36. The position of strap connector 36 may be moved along straps 32, 34 to adjust the fit of the face mask 10 on the face of the wearer. In this arrangement, the straps 32, 34 that are coupled via the connector 36 may be positioned around the head of the wearer. In some implementations, straps 32, 34 may be configured to form loops to be fit around the ears of a wearer. In this arrangement, the connector 36 may be removed from the straps 32, 34.

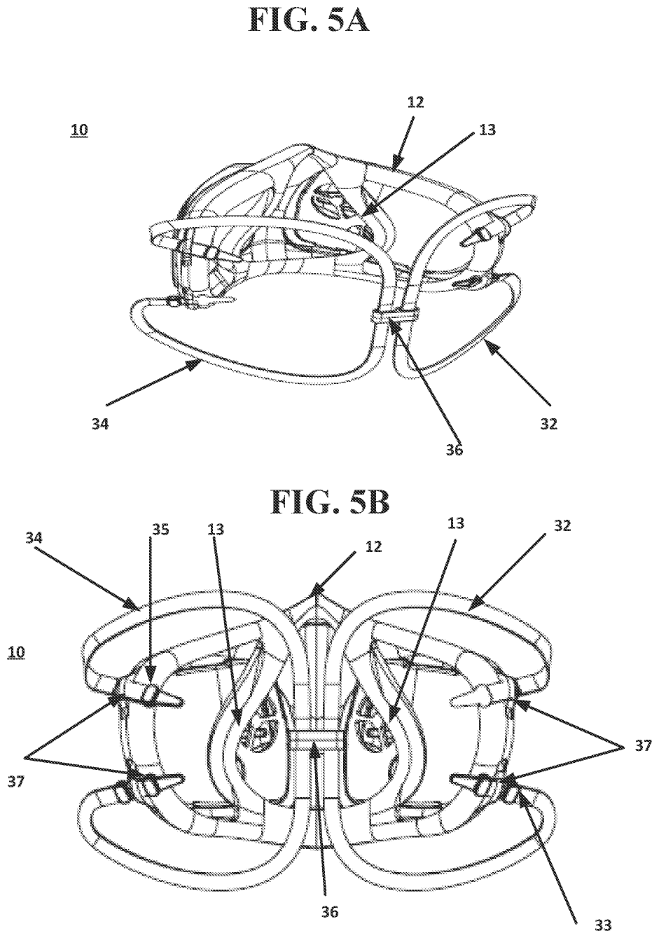

Seal 13, as shown in FIGS. 2B, 5A, and 5B may be used to seal the face mask 10 to the face of the wearer. In particular, seal 13 may maintain a seal around the mouth and/or nose of the wearer. Portions of the body 12 may also form a seal between the face mask 10 and the face of the wearer.

In the face mask 10 shown in FIGS. 1A-5B and described above, the valves 28, 30 at the bottom of the face mask 10 may lock (e.g., valves 28, 30 may lock with valve interfaces 29, 31) when the wearer breathes in. The locking may cause the airflow to come through the filters 16, 22 into the cavity behind the filters 16, 22 and through the single directional air pass valve 26 and valve interface 25 into the section defined by the seal 13 of the face mask 10, which may allow the wearer to breathe.

The seal 13, the valve 26, and/or the valve interface 25 may be configured in size, arrangement, and/or adjustment to provide a suitable breathing pressure for the wearer while maintaining an airlock, so as much air as possible runs through the filters 16, 22 of the face mask 10 and does not come in via the edges around the body 12 and/or the seal 13.

The face mask 10 may be configured so that when the wearer breathes out, the single directional airflow valve (e.g., valve 26 and valve interface 25) around the filters 16, 22 lock so that hot air is passed out through under the chin of the wearer.

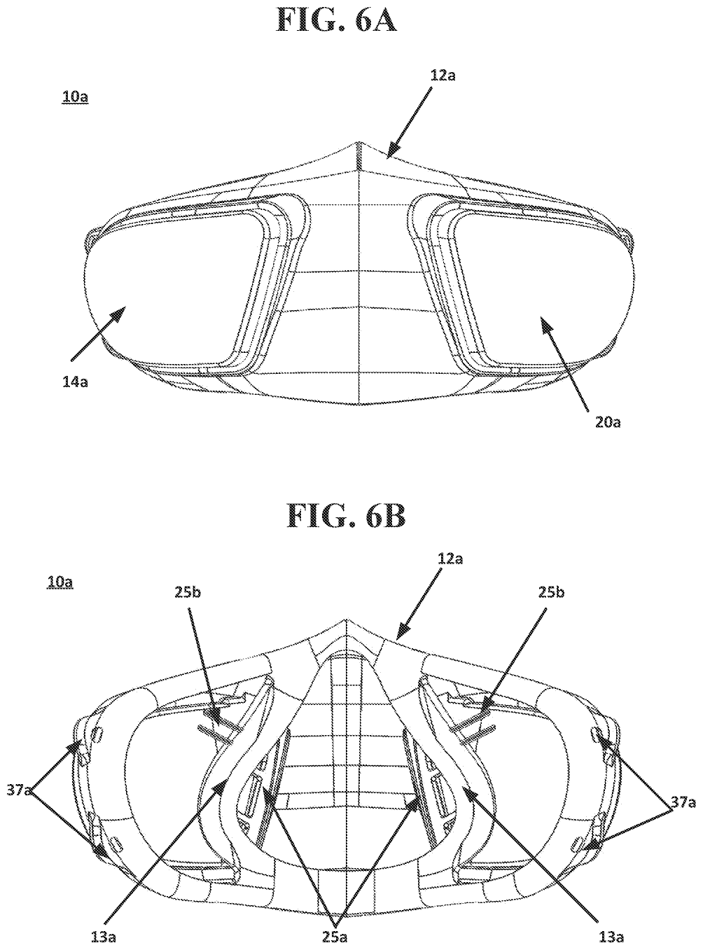

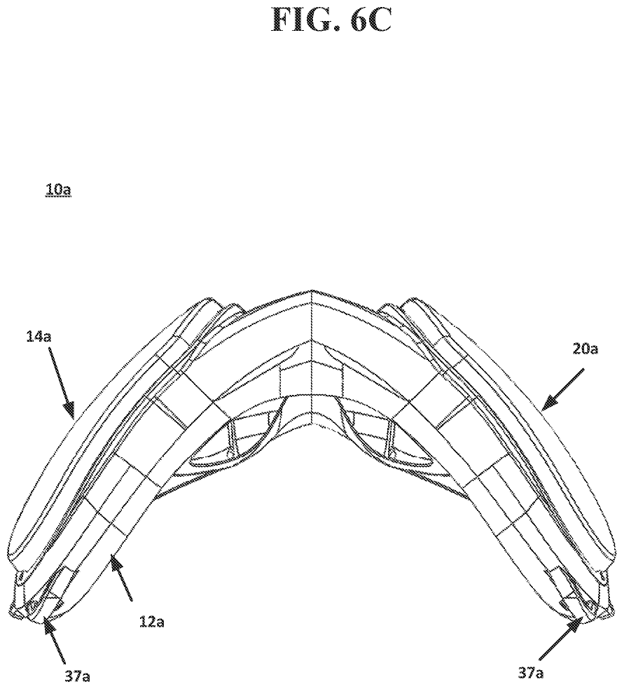

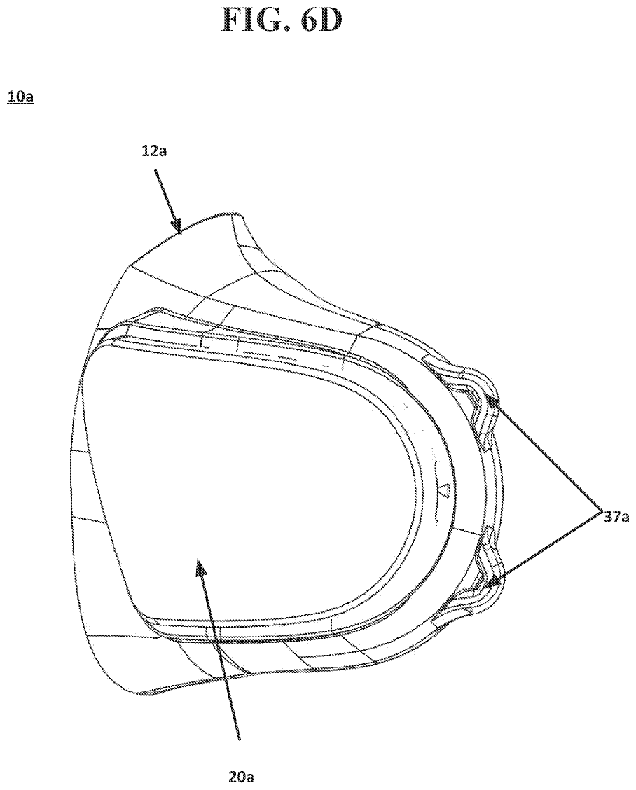

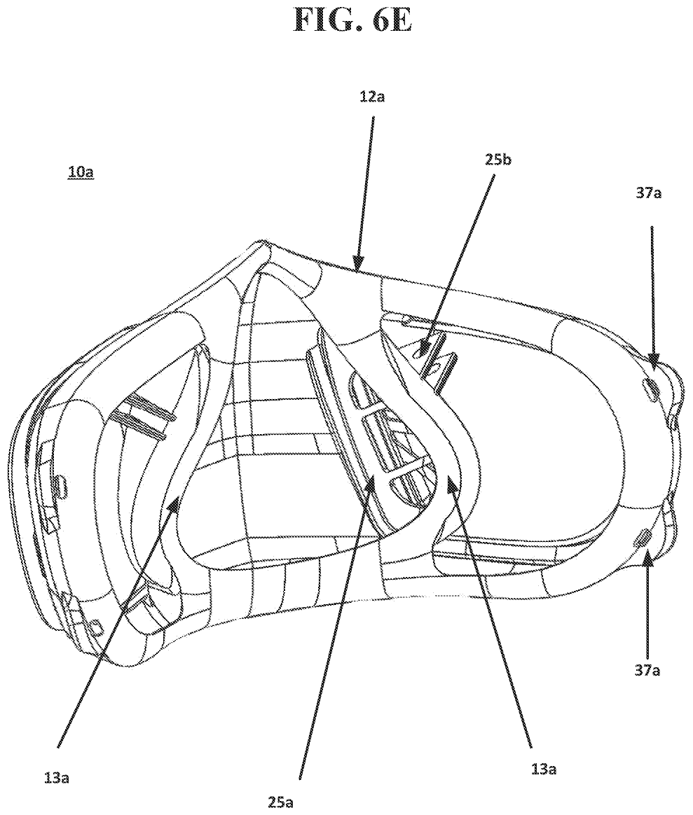

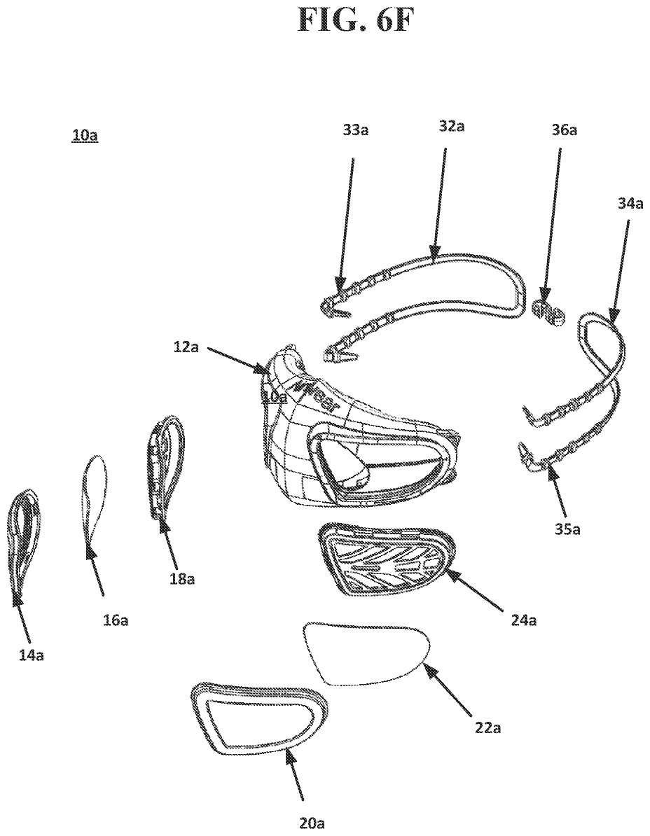

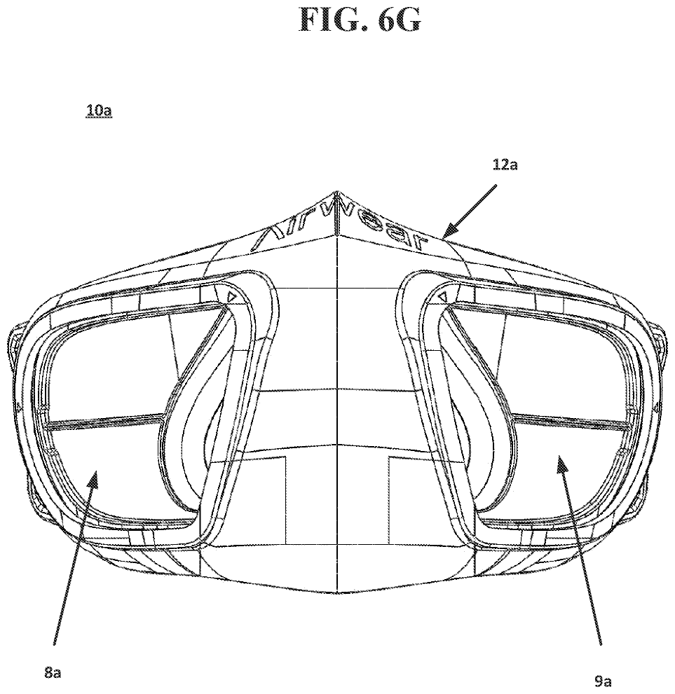

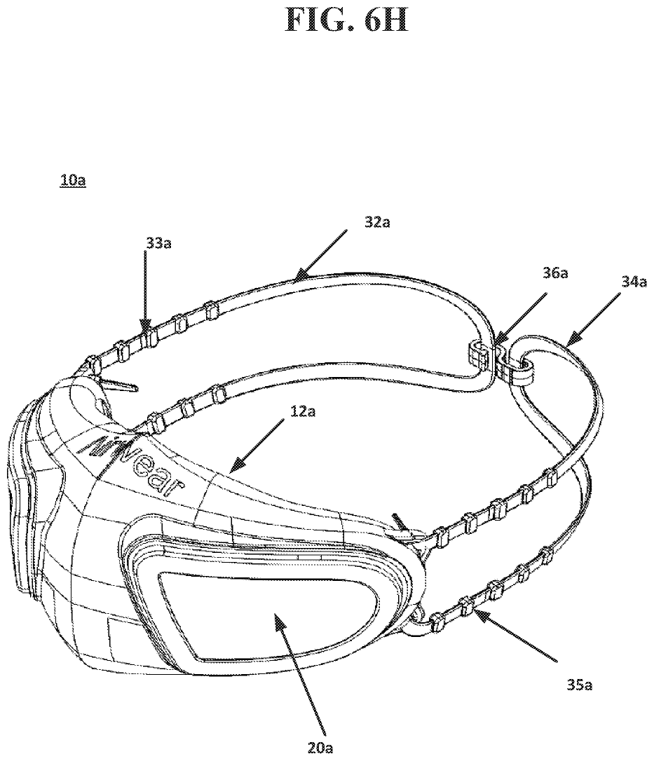

FIGS. 6A-6H show views of a second implementation of the face mask of FIGS. 1A-5B described above. The face mask 10a of FIGS. 6A-6H may be similar and/or the same as face mask 10 of FIGS. 1A-5B, but may include vents 25a, 25b rather than the valves 26 and valve interfaces 25. The vents 25a, 25b may be adjustable and/or bi-directional so that air goes out and in through the filters (e.g., filters 16, 22 shown in FIG. 1B) while maintaining an airlock (e.g., between the body 12a, seal 13a and the face of the wearer). The face mask 10a may not include valves 28, 30 that are included on the body 12 of face mask 10. For example, FIG. 6C shows a bottom view of the body 12a that does not include valves 28, 30 and valve interfaces 29, 31. Eyelets 37a may be similar and/or the same as eyelets 37, and may accept straps 32a, 34a having tabs 33a, 35a that may be used to adjust the length. The straps 32a, 34a may either be positioned around a head of a wearer, or may be disposed on the ears of the wearer. The face mask 10a may include filters and/or filter covers that may be disposed on the body 12a, and/or may be press fit to the body 12a.

The section of the face mask 10a that includes seal 13a may provide a larger hole that is bi-directional, so the air goes out and in through the filters (e.g., filters similar to filters 16, 22 shown in FIG. 1B of face mask 10) while maintaining an airlock. If the hole is too large, then the airlock formed by the seal 13a and/or body 12a may be compromised.

That is, other than valves 28, 30 and valve interfaces 29, 31 of mask 10, the portions and/or components of mask 10a of FIGS. 6A-6H may be similar to those of mask 10 shown in FIGS. 1A-5B and described above. The opening 8, opening 9, body 12, seal 13, outside filter cover 14, filter 16, inside filter cover 18, outside filter cover 20, filter 22, inside filter cover 24 20, strap 32, tab 33, strap 34, tab 35, connector 36, and eyelets 37 of mask 10 shown in FIGS. 1A-5B and described above may be similar to opening 8a, opening 9a, body 12a, seal 13a, outside filter cover 14a, filter 16a, inside filter cover 18a, outside filter cover 20a, filter 22a, inside filter cover 24a, strap 32a, tab 33a, strap 34a, tab 35a, connector 36a, and eyelets 37a of mask 10a shown in FIGS. 6A-6H.

In the implementations shown in FIGS. 1A-6H, the face mask 10, 10a may include a transparent portion (e.g., body 12, 12a) that may be configured to cover a nose and mouth when disposed on a wearer. The transparent portion of body may include a left front opening (e.g., opening 8, 8a) and a right front opening (e.g., opening 9, 9a). A first strap (e.g., strap 32, 32a) and a second strap (e.g., strap 34, 34a) may be affixed to the transparent portion at eyelets 37 using tabs (e.g., tabs, 33, 33a, 35, 35a).

A first filter (e.g., filter 16, 16a) may be configured to be removably disposed in the left front opening (e.g., opening 8, 8a) of the transparent portion of body 12, 12a to filter air. A second filter (e.g., filter 22, 22a) may be configured to be removably disposed in the right front opening (e.g., opening 9) of the transparent portion of body 12, 12a to filter the air.

The face mask 10, 10a may include a removeable first front cover (e.g., outside filter cover 14, 14a) and a removeable first back cover (e.g., inside filter cover 18, 18a), the first filter (e.g., filter 16, 16a) may be removably disposed between the first front cover and the first back cover to form a first assembly. The first assembly may be configured to be removably disposed in the left front opening (e.g., opening 8, 8a) of the transparent portion of the body 12, 12a of the face mask 10, 10a and form a seal with an edge of the left front opening (e.g., opening 8, 8a). The face mask 10, 10a may include a second front cover (e.g., outside filter cover 20, 20a) and a second back cover (e.g., inside filter cover 24, 24a), where the second filter (e.g., filter 22, 22a) may be removably disposed between the second front cover and the second back cover to form a second assembly. The second assembly may be configured to be removably disposed in the right front opening (e.g., opening 9, 9a) of the transparent portion and form a seal with an edge of the right front opening.

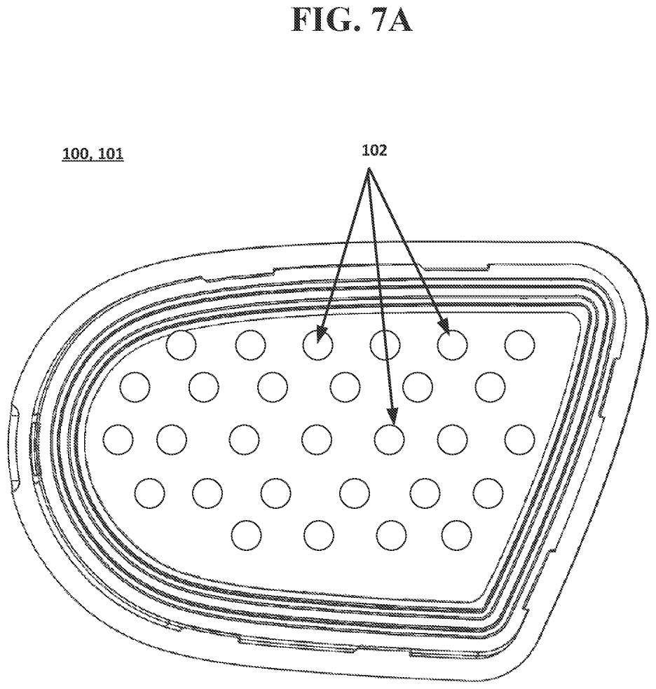

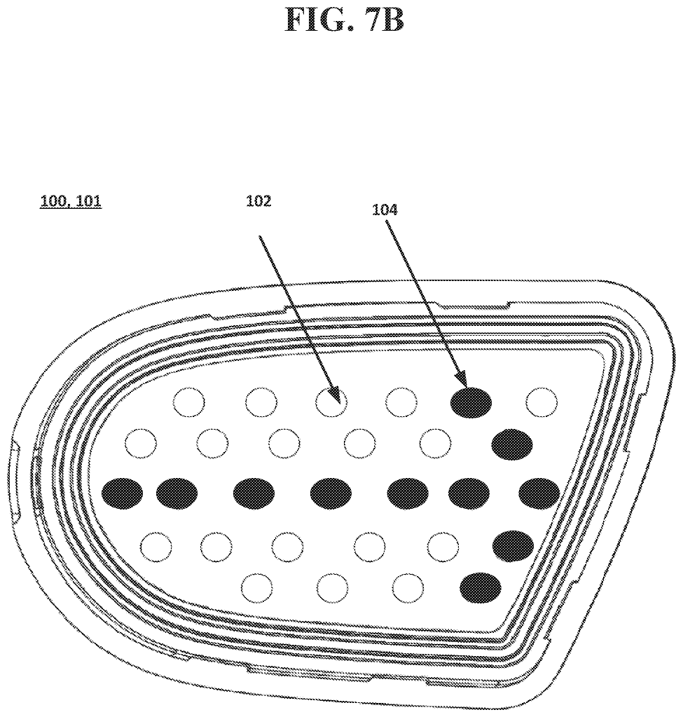

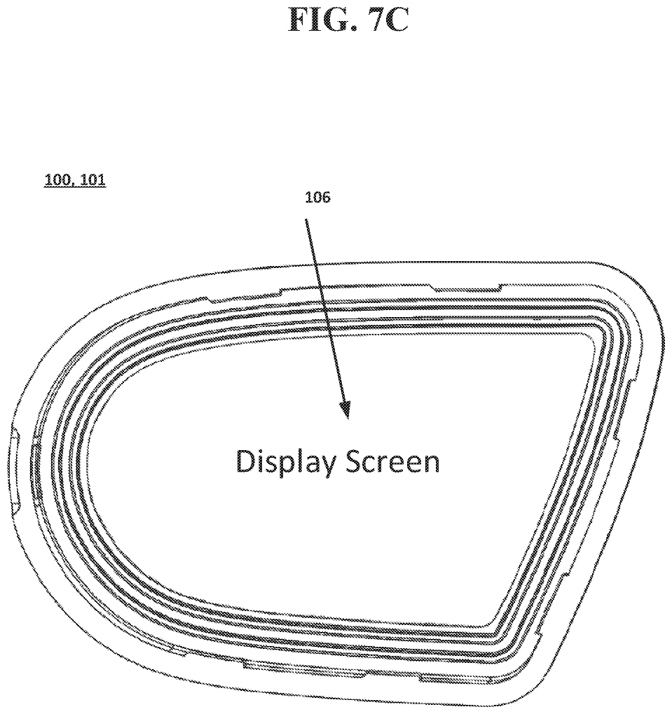

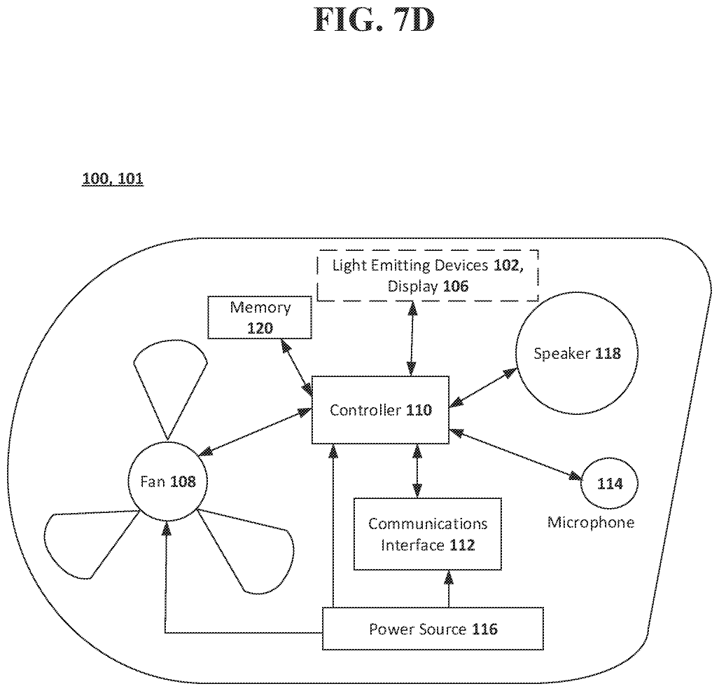

FIGS. 7A-7D show example modules 100, 101 that may be affixed to face mask 10, 10a of FIGS. 1A-6H according to implementations of the disclosed subject matter. For example, the module 100, 101 shown in FIGS. 7A-7B may include a plurality of light emitting devices 102. In one implementation, the module 100, 101 may include a display 106, as shown in FIG. 7C. FIG. 7D shows one or more components that may be included within the module 100, 101, such as fan 108, controller 110, communications interface 112, microphone 114, power source 116, speaker 118, and/or memory 120 as described below. In some implementations, there may be one or more holes in the modules 100, 101 so as to allow air to pass through that has been filtered or is to be filtered by filters 16, 16a, 22, and/or 22a.

In one example of affixing the module 100, 100 to the face mask 10, 10a, the first back cover (e.g., inside filter cover 18, 18a) may be replaced by a first module 100. The first module 100 may be affixed to the first filter (e.g., filter 16, 16a), and the second back cover (e.g., inside filter cover 24, 24a) may be replaced by a second module 101 when the second module 101 is affixed to the second filter (e.g., filter 22, 22a).

A first module 100 may be configured to be removably affixed to the filter 16, 16a and a second module 101 may be configured to be affixed to the filter 22, 22a. At least one of the first module 100 and the second module 101 may include a controller 110 and at least one of a fan 108, a speaker 118, a microphone 114, a display 106, a memory 120, a communications interface 112, and/or a plurality of light emitting devices 102. The face mask 10, 10a may provide filtration with the replaceable filters 16, 16a, 22, and/or 22a and may also include removeable modules 100, 101 that may be coupled to the filters 16, 16a, 22, and/or 22a.

That is, inside filter covers 18, 18a, 24, and/or 24a may be replaced with the replaceable modules 100, 101, which may be coupled to the outside filter covers 14, 14a, 20, and/or 20a. The outside filter cover 14, the filter 16, and the replaceable module 100 may be disposed in opening 8, 8a of the body 12, 12a of the face mask 10, 10a, and may form a seal with an edge of the opening 8, 8a. Similarly, the outside filter cover 20, 20a the filter 22, 22a and the replaceable module 101 may be disposed in opening 9, 9a of the body 12, 12a of the face mask 10, 10a, and may form a seal with an edge of the opening 9, 9a. The modules 100, 101 may include a flange or the like to form the seal with the transparent portion of the body 12, 12a of the face mask 10, 10a.

In some implementations, the outside filter covers 14, 14a, 20, and/or 20a may be replaced by the modules 100, 101. The module 100, the filter 16, and the inside filter cover 18 may be disposed in opening 8, 8a of the body 12, 12a of the face mask 10, 10a, and may form a seal with an edge of the opening 8, 8a. Similarly, the module 101, the filter 22, 22a, and the inside filter cover 24, 24a may be disposed in opening 9, 9a of the body 12, 12a of the face mask 10, 10a, and may form a seal with an edge of the opening 9, 9a.

The first module 100 and/or the second module 101 may include a power source 116 to provide electrical power to the controller 110, the fan 108, the speaker 118, the microphone 114, the display 106, the communications interface 112, a memory 120, and/or the plurality of light emitting devices 102. The power source 116 may be a battery, a rechargeable battery, or the like.

The fan 108 of the module 100, 101 may be controlled by the controller 110 to turn on and off, and/or to operate at one or more speeds. The fan 108 may provide air circulation within the face mask 10, 10a and may provide increased comfort for the wearer of the face mask 10, 10a. The fan 108 may remove moisture from within the face mask 10, 10a, when the face mask 10, 10a is being worn and the wearer is breathing.

In some implementations, the fan 108 may be controlled by the controller 110 to create air pressure within the face mask 10, 10a using the seal 13, 13a and/or body 10, 12a to seal the mask to the face of the wearer. The controller 110 may increase and/or decrease the speed of the fan to increase and/or decrease air pressure within the body 12, 12a of the face mask 10, 10a, where the pressure may open the air passages within the mouth and/or nose of the wearer to assist in breathing. In some implementations, a mobile device 202 may communicate via the communications interface 112 to control the air pressure and/or breathing environment of the wearer of the face mask 10, 10a when the fan 108 is operating.

The speaker 118 of the removeable module 100 101 may output sound and/or voice based on a signal from the controller 110 and/or the communications interface 112. For example, the module 100, 101 may be used for voice amplification, such as through the speaker 118. That is, when a wearer talks, microphone 114 of the module 100, 101 may convert the voice to a signal that may be amplified and output by the speaker 118. In another example, signals received by the communications interface 112 may be output by the speaker 118 (e.g., as voice, music, and/or other sounds).

The memory 120 may use any suitable combination of any suitable volatile and non-volatile physical storage mediums, including, for example, read only memory (ROM), random access memory (RAM), a solid state drive, flash memory, registers, or the like, or any combination thereof. In some implementations, the memory 120 may be communicatively coupled to the controller, and may store one or more configuration settings for the operation of the face mask 10, 10a. For example, the memory 120 may store settings for voice commands that may be received by the microphone 114 and provided to the controller 110. The voice commands may control, for example, the operation of the fan 108 (e.g., turn on or off, change the fan speed, or the like), the operation of the light emitting devices (e.g., turn on all of the light emitting devices 102 for illumination, illuminate particular light emitting devices 102 to form a symbol and/or display text, operate the display 106 to display text and/or a symbol, or the like).

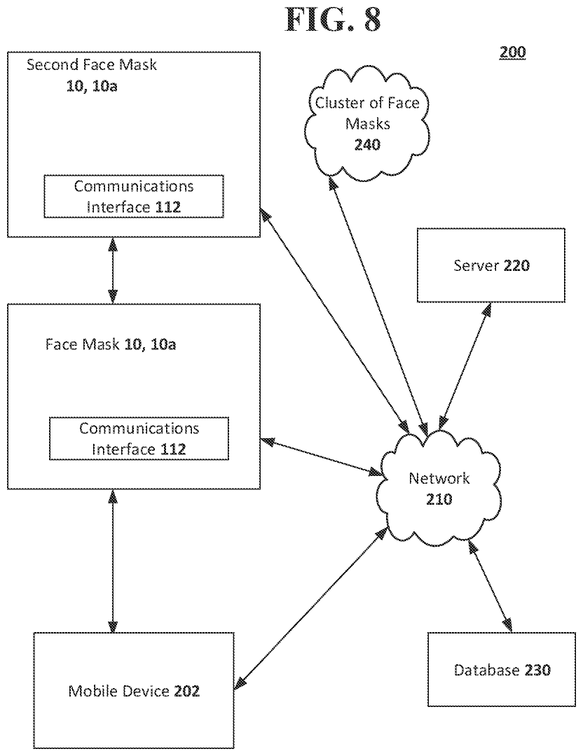

The communications interface 112 may provide communication between first module 100 and second module 101 of the face mask 10, 10a, and/or provide communications with other mobile devices (e.g., a smart phone, smart watch, tablet computer, or the like) and/or with other devices (e.g., a server, a database, or the like) via a communications network. For example, FIG. 8 shows that the face mask 100, 101 may be communicatively coupled to a mobile device 202, and/or to server 220 and/or database 230 via communications network 210. The microphone 114 may convert voice to a signal that may be transmitted via the communications interface 112. In another example, the face mask 10, 10 may be communicatively coupled to a second face mask 10, 10a, where data and/or other information may be provided between the face masks 10, 10a via the communications link.

The microphone 114 of the module 100, 101 may be connected to the communications interface 112, which may form a wireless communications link between the face mask 10, 10a and a mobile device (e.g., mobile device 202 shown in FIG. 8, which may be a smart phone, smart watch, wearable computing device, or the like). For example, voice may be converted by the microphone 114 to a signal, which may be transmitted to the mobile device (e.g., mobile device 202, which may be a smart phone of the wearer of the mask), and from the mobile device to a communications network (e.g., network 210 shown in FIG. 8) to one or more other devices. The microphone 114, controller 110, and communications interface 112 may transmit a wearer's commands and/or speech to a server (e.g., server 220 shown in FIG. 8) or mobile device (e.g., mobile device 202 shown in FIG. 8) which may perform a language translation, where the translated voice may be output as text on the display 106 and/or by the light emitting devices 102. In some implementations, the display 106 and/or the light emitting devices 102 may output the text of the received voice, and the translated text of the voice. In some implementations, the display 106 or the light emitting devices 102 of a first module 100 may output the text of the received voice, and the display 106 or the light emitting devices 102 of the second module 101 may output the translated text.

The module 100, 101 may include a display 106, which may be an organic light emitting diode (OLED) display, a light emitting diode (LED) display, a liquid crystal display (LCD), or the like. The display 106 may display images, text, symbols, or the like. An example of a module 100, 101 with a display 106 is shown in FIG. 7C. In some implementations, the module 100, 101 including the display 106 may include one or more holes to allow air to pass through the module 100, 101, where the air may be filtered by filters 16, 16a, 22, and/or 22a.

In some implementations, the module 100, 101 may include a plurality of light emitting devices 102 (e.g., as shown in FIG. 7A). The light emitting devices may be OLEDs, LEDs, light bulbs, and/or other suitable light emitting elements. The light emitting devices may display text, symbols (e.g., as shown in FIG. 7B, which includes illuminated light emitting devices 104), and/or provide illumination (e.g., so that the wearer of the face mask 10, 10a may be more visible to others, such as in low light conditions). In some implementations, the module 100, 101 including the plurality of light emitting devices may include one or holes to allow air to pass through the module 100, 101, where the air may be filtered by filters 16, 16a, 22, and/or 22a.

The display 106 and/or the plurality of light emitting devices 102 may display symbols, messages (e.g., in text), text, translated text, or the like. In some implementations, the display 106 and/or the light emitting devices 102 may output text in a first language, and the translated text that is in a second language. In some implementations, the display 106 or the light emitting devices 102 of a first module 100 may output the text in the first language, and the display 106 or the light emitting devices 102 of the second module 101 may output the translated text that is in a second language. Light may be output so that the wearer of the face mask 10, 10a may be visible, and/or to provide illumination. Scrolling text may be output by the display and/or light emitting devices of the module. The scrolling text may move from one module of the face mask to another, such as from the display of the left module to the display of the right module. Symbols, text, lighting patterns, or the like may be scrolled across the displays of the modules of the face mask, and/or may be synchronized. For example, the plurality of light emitting devices may be controlled to be synchronized to music, and/or may control the synchronization of illumination of one or more of the light emitting devices over different modules and/or masks (via a wireless communications link) in clusters of persons wearing the face mask or in a linear arrangement of persons wearing the face mask.

The controller may be a processor, an integrated circuit, a field programmable gate array, a programmable logic device, or the like. The controller 110 of the module 100, 101 may be configured to control the display 104 to output at least one image. In some implementations, the controller 110 may be configured to control the plurality of light emitting devices 102 to output light (e.g., where FIG. 7B shows illuminated light emitting devices 104). The controller may control the display 106 and/or the plurality of light emitting devices 102 to output symbols, an alert message, a safety message, text, and/or scrolling text. In some implementations, the controller may control the light emitting devices to output light for safety purposes (e.g., to make the wearer of the face mask 10, 10a visible to others in low light conditions). The first module 100 and the second module 101 may include the display 106 and/or the plurality of light emitting devices 102. The controller 110 may control the output of the scrolling text from the first module 100 to the second module 101.

The controller 110 may receive a first signal from the microphone 114 based on a received voice or sound from the wearer of the face mask 10, 10a, and may generate a second signal to output text of the received voice on the display 106 and/or the plurality of light emitting devices 102. That is, the controller 110 may convert the first signal with the voice to a second signal that is used to display text that corresponds to one or more words in the first signal.

In some implementations, the controller 110 may receive a first signal from the microphone 114 based on a received voice in a first language, may translate the first language of the first signal to a second language, may generate a second signal, and may output the generated second signal to the speaker 118, the display 106, the plurality of light emitting devices 102, and/or the communications interface 112. That is, the generated second signal may be used to output one or more words that correspond with the words in the first signal to be output at the display 104 or the light emitting device 102, but in a different language. Alternatively, the generated second signal may be used to output sound from the speaker 118 that corresponds to the words of the first signal, but in a different language.

The controller 110 may receive a first signal from the microphone 114 based on a received voice in a first language, may transmit the first signal via the communications interface 112, may receive a second signal that is a translation of the first language into a second language (e.g., via communications network 210, where server 220 may translate the first language to the second language), and may output the second signal to the speaker 118, the display 106, and/or the plurality of light emitting devices 102. For example, the first signal may be transmitted via the communications interface 112 over a wireless communication link to mobile device 202 and/or server 220 shown in FIG. 8, which may translate the first signal from a first language to a second language. The mobile device 202 and/or server 220 may generate a second signal that may include the translation, and may transmit the second signal to the communications interface 112 of the module 100, 101. The controller 110 may output the first signal and/or the second signal to the speaker 118, the display 106, and/or the plurality of light emitting devices 102. In some implementations, the first signal may be output by the speaker 118, the display 106, and/or the plurality of light emitting devices 102 of the first module 100, and the second signal may be output by the speaker 118, the display 106, and/or the plurality of light emitting devices 102 of the second module 101.

The controller 110 may control the plurality of light emitting devices 102 to output light that may be synchronized to sound, voice, and/or music. For example, music, sound, and/or voice signals may be received by the controller via the communications interface, and may be output via the speaker 118. When the controller is outputting the music, sound, and/or voice signals to the speaker and/or another output device that is communicatively connected to the communications interface 112, the controller 110 may control the output of light from the plurality of light emitting devices 102 to be synchronized with the music, sound, and/or voice signals. The controller may synchronize the music, sound, and/or voice signals with light output from the light emitting devices based on rhythmic patterns, volume levels, tempo, or the like of the music, sound, and/or voice signals.

FIG. 8 shows an example system 200 with a face mask 10, 10a that may include the first module 100 and/or the second module 101 with a communications interface 112 that may be communicatively coupled to a mobile device 202 and/or a communications network 210 having one or more servers 220 and/or databases 230. The communications interface 112 may be communicatively coupled to the mobile device via a local network such as via Wi-Fi, radio frequency (RF) communication, BlueTooth™, or other suitable communications link. Communications network 210 may be wired and/or wireless communication network that may be a local area network, a wide area network, the Internet, an intranet, or the like. As described above, face mask 10, 10a may transmit data (e.g., voice signals or other data) via the communications interface 112 to the mobile device 202, the server 220, and/or the database 230 to be processed (e.g., translate words in the voice signal from one language to another, or the like). The mobile device 202 may be a smartphone, a smart watch, a wearable computing device, a tablet computer, a personal assistant computing device, and/or any other suitable device and/or computer.

The communications interface 112 may receive data from mobile device 202, server 220, and/or database 230 to be used for one or more operations of the first module 100 and/or the second module 101 for the face mask 10, 10a. For example, the received data may be displayed on the display 106 (e.g., images, symbols, messages, or the like), may control the output of the light emitting devices 102 (e.g., to display patterns, scroll text, display symbols, display text, or the like), output sound from the speaker 118, or the like.

FIG. 8 shows a second face mask 10, 10a which may be communicatively coupled to the face mask 10, 10a via a communications link, such as via Wi-Fi, radio frequency (RF) communication, BlueTooth™, or other suitable communications link. As described above, the communication between the masks may provide for data to be exchanged between the face masks 10, 10a to synchronize the illumination of the light emitting devices 102, output of text, images, or the like to display 106, and/or transmit voice signals captured by the microphone 114, which may be output by speaker 118.

In some implementations, the face mask 10, 10a may include the first module 100 and the second module 101, a communication link may be formed between the first and second modules 100, 101. The communications link may be Wi-Fi, radio frequency (RF) communication, BlueTooth™, or other suitable communications link. Synchronization of illumination of the light emitting devices 102 may be performed when the modules 100, 101 are linked. In another example, the communications link between the modules 100, 101 may allow text, symbols, or the like to be scrolled by the light emitting units 102 or display 106 from module 100 to module 101.

In some implementations, a plurality of face masks 10, 10a may be communicatively coupled with one another in a cluster 240 via communications interface 112. The cluster 240 may be communicatively coupled to the server 220 and/or the database 230 via the network 210. In this arrangement, one of the face masks 10, 10a, the server 220, and/or the mobile device 202 may control the operation of the face masks 10, 10a of the cluster 240. For example, the cluster 240 may be controlled to output light, text, symbols, messages, advertisements, or the like on the display 106 or the light emitting devices 102. In another example, the speakers 118, the light emitting devices 102, and/or the displays 106 of the cluster 240 may be synchronized to output sound, music, images, text, scrolling text, symbols, or the like. In yet another example, the output of the light emitting devices 102 and/or the displays 106 may output images, text, light, symbols, or the like that is synchronized with sound and/or music that may be output by the speakers 118 or other sound source.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various embodiments with various modifications as may be suited to the particular use contemplated.

1. A face mask, comprising:
a transparent portion configured to cover a nose and mouth when disposed on a wearer, wherein the transparent portion includes a left front opening and a right front opening;
a first strap and a second strap that are affixed to the transparent portion;
a first filter configured to be removably disposed in the left front opening of the transparent portion to filter air;
a second filter configured to be removably disposed in the right front opening of transparent portion to filter the air; and
a first module configured to be removably affixed to the first filter and a second module configured to be affixed to the second filter, where at least one of the first module and the second module includes a controller and at least one selected from the group consisting of: a fan, a speaker, a microphone, a display, a memory, a communications interface, and a plurality of light emitting devices.

2. The face mask of claim 1, wherein the transparent portion is foldable.

3. The face mask of claim 1, further comprising:
a first front cover and a first back cover, wherein the first filter is removably disposed between the first front cover and the first back cover to form a first assembly, wherein the first assembly is configured to be removably disposed in the left front opening of the transparent portion and form a seal with an edge of the left front opening; and
a second front cover and a second back cover, wherein the second filter is removably disposed between the second front cover and the second back cover to form a second assembly, wherein the second assembly is configured to be removably disposed in the right front opening of the transparent portion and form a seal with an edge of the right front opening.

4. The face mask of claim 3, wherein the first front cover and the first back cover have a first plurality of openings, and
wherein the second front cover and the second back cover have a second plurality of openings.

5. The face mask of claim 3, wherein the first back cover is the first module when the first module is affixed to the first filter, and the second back cover is the second module when the second module is affixed to the second filter.

6. The face mask of claim 1, further comprising:
a power source to provide electrical power to the controller and at least one selected from the group consisting of: the fan, the speaker, the microphone, the display, the communications interface, the memory, and the plurality of light emitting devices

7. The face mask of claim 1, further comprising:
one or more valves disposed on a bottom portion of the transparent portion of the face mask configured to regulate airflow out of the face mask.

8. The face mask of claim 1, further comprising:
a first valve disposed on a left side of the face mask configured to be covered by the first filter; and
a second valve disposed on a right side of the face mask configured to be covered by the second filter,
wherein the first value and the second valve are configured to regulate air flow out of the mask.

9. The face mask of claim 1, wherein the controller is configured to control at least one selected from the group consisting of: the display to output at least one image, and the plurality of light emitting devices to output light.

10. The face mask of claim 9, wherein the controller controls the display or the plurality of light emitting devices to output at least one selected from the group consisting of: symbols, an alert message, a safety message, text, and scrolling text.

11. The face mask of claim 10, wherein the first module and the second module both include at least of the display and the plurality of light emitting devices, wherein the controller controls the output of the scrolling text from the first module to the second module.

12. The face mask of claim 1, wherein the controller receives a first signal from the microphone based on a received voice a second signal, and generates a second signal to output text of the received voice on at least one selected from the group consisting of: the display, and the plurality of light emitting devices.

13. The face mask of claim 1, wherein the controller receives a first signal from the microphone based on a received voice in a first language, translates the first language of the first signal to a second language, generates a second signal, and outputs at least one of the first signal and the generated second signal to at least one selected from the group consisting of: the speaker, the display, the plurality of light emitting devices, and the communications interface.

14. The face mask of claim 1, wherein the controller receives a first signal from the microphone based on a received voice in a first language, transmits the first signal via the communications interface, receives a second signal that is a translation of the first language into a second language, and outputs at least one of the first signal and the second signal to at least one selected from the group consisting of: the speaker, the display, the plurality of light emitting devices, and the communications interface.

15. The face mask of claim 1, wherein the controller controls the plurality of light emitting devices to output light that synchronizes to at least one selected from the group consisting of: sound, voice, and music.

16. The face mask of claim 1, wherein the first strap has a first end and a second end, wherein the first end and the second end are affixed to different portions of a left side of the transparent portion of the face mask to form a first loop, and
wherein the second strap has a first end and a second end, wherein the first end and the second end are affixed to different portions of the right side of the transparent portion of the face mask to form a second loop.

17. The face mask of claim 16, further comprising:
a connector configured to affix the first strap to the second strap,
wherein the connector is configured to be adjustable to a first position of the first strap and to a second position on the second strap.
